(19) United States
(12) Patent Application Publication
(10) Pub. No.: US 2026/0056313 A1
(43) Pub. Date: Feb. 26, 2026

(54) CONFORMAL ANTENNA FOR SYNTHETIC APERTURE RADAR APPLICATION

(71) Applicant: Technology Innovation Institute - Sole Proprietorship LLC, Masdar City (AE)

(72) Inventors: Luciano Prado De Oliveira, Abu Dhabi (AE); Edson Cesar Reis, Sao Paulo (BR); Mae Nasser Saif Majed AlMansoori, Abu Dhabi (AE); Jose Felix Vega Stavro, Abu Dhabi (AE); Chaouki Kasmi, Abu Dhabi (AE)

(73) Assignee: Technology Innovation Institute - Sole Proprietorship LLC, Masdar City (AE)

(21) Appl. No.: 19/268,094

(22) Filed: Jul. 14, 2025

(30) Foreign Application Priority Data
Aug. 26, 2024 (AE) P2024-02217

(51) Int. Cl. G01S 13/90; H01Q 1/02; H01Q 1/28; H01Q 1/42; H01Q 1/52; H01Q 21/20

(52) U.S. Cl. CPC G01S 13/9076; H01Q 1/02; H01Q 1/28; H01Q 1/42; H01Q 1/523; H01Q 21/20

(57) ABSTRACT

A conformal antenna system for Synthetic Aperture Radar (SAR) applications, the system comprising a tubular POD, a curved vertically polarized radio frequency (RF) antenna conformally integrated into a curved surface of the tubular POD at a first location, and a curved horizontally polarized RF antenna conformally integrated into the curved surface of the tubular POD at a second location, wherein the first location and the second location are arranged such that the curved vertically polarized RF antenna and the curved horizontally polarized RF antenna share a common RF emission axis.

### CROSS-REFERENCE TO RELATED APPLICATIONS

This application claims priority to United Arab Emirates Patent Application No. P2024-02217, which was filed on Aug. 26, 2024, the entire contents of which is incorporated by reference herein.

### FIELD

A conformal antenna for synthetic aperture radar application.

### BACKGROUND

Synthetic Aperture Radar (SAR) systems are a type of imaging radar used in geophysical surveys and surveillance applications. SAR systems are capable of producing high-resolution images of a landscape, including its topography and any structures or objects on it, by emitting and then receiving radar signals. These systems are often deployed on various aerial platforms such as satellites, airplanes, and drones.

SAR systems typically operate by transmitting electromagnetic waves towards the ground from an antenna mounted on the aerial platform. The waves are backscattered to the antenna by the ground and any objects on it. The time it takes for the waves to return, and the phase shift of the returned waves are measured to create a two-dimensional (2D) image of the landscape. By combining multiple 2D images taken from different positions, a three-dimensional (3D) model of the landscape can be generated, a process known as SAR tomography.

However, the design and implementation of antennas for SAR systems present several physical challenges. For instance, the antennas' size and weight can limit the types of aerial platforms they can be mounted on. Furthermore, the antennas' mechanical strength and aerodynamic properties can affect the flight performance of the aerial platform. Additionally, the antennas' performance can be affected by environmental conditions such as low temperatures and high humidity.

### SUMMARY

In one aspect, the present disclosure relates to a conformal antenna system for Synthetic Aperture Radar (SAR) applications, the system comprising a tubular POD, a curved vertically polarized radio frequency (RF) antenna conformally integrated into a curved surface of the tubular POD at a first location, and a curved horizontally polarized RF antenna conformally integrated into the curved surface of the tubular POD at a second location, wherein the first location and the second location are arranged such that the curved vertically polarized RF antenna and the curved horizontally polarized RF antenna share a common RF emission axis.

In embodiments of this aspect, the disclosed system according to any one of the above example embodiments, wherein the tubular POD is composed of composite materials selected from the group consisting of fiberglass, carbon fiber, and Kevlar, providing lightness, rigidity, and aerodynamic stability to the POD.

In embodiments of this aspect, the disclosed system according to any one of the above example embodiments, further comprising a heated surface on the tubular POD to prevent ice accumulation.

In embodiments of this aspect, the disclosed system according to any one of the above example embodiments, wherein the curved vertically polarized RF antenna and the curved horizontally polarized RF antenna are oriented relative to each other to reduce interference and improve compactness of the system while maintaining emission along the common RF emission axis.

In embodiments of this aspect, the disclosed system according to any one of the above example embodiments, further comprising reflectors positioned in the tubular POD to guide RF waves emitted by the curved vertically polarized RF antenna and the curved horizontally polarized RF antenna towards a common target without causing interference between the vertically and horizontally polarized waves.

In embodiments of this aspect, the disclosed system according to any one of the above example embodiments, wherein the curved horizontally polarized RF antenna comprises a V-shaped planar array stacking configuration, the V-shape being oriented obliquely with respect to the axis of the tubular POD to reduce angular beamwidth of a main lobe in an azimuth direction and increase an area of the antenna in the direction of the POD's axis.

In embodiments of this aspect, the disclosed system according to any one of the above example embodiments, wherein radiating elements of the curved vertically polarized RF antenna and the curved horizontally polarized RF antenna are staggered along each respective antenna boom to increase a length of curved vertically polarized RF antenna and the curved horizontally polarized RF antenna.

In embodiments of this aspect, the disclosed system according to any one of the above example embodiments, wherein the curved vertically polarized RF antenna and the curved horizontally polarized RF antenna are oriented at a 90-degree angle relative to each other, such that the orientation of their respective radiating elements determines the polarization of emitted RF waves.

In embodiments of this aspect, the disclosed system according to any one of the above example embodiments, further comprising an aerodynamic cap on at least one end of the tubular POD, the aerodynamic cap being configured to reduce drag along the tubular POD.

In embodiments of this aspect, the disclosed system according to any one of the above example embodiments, further comprising coolant lines integrated within the tubular POD, wherein the coolant lines are configured to circulate a coolant to dissipate heat generated by the curved vertically polarized RF antenna, the curved horizontally polarized RF antenna, and supporting electronic devices.

In one aspect, the present disclosure relates to an aerial drone configured for conducting aerial surveys of ground objects and subsurface objects, the drone comprising a body having an aerodynamic shape for flight, and a conformal antenna system mounted to a side of the body, an axis of the conformal antenna system is oriented in a flying direction of the drone such that radio frequency (RF) emissions radiate from the side of the drone down towards Earth, the conformal antenna system comprising a tubular POD, a curved vertically polarized RF antenna conformally integrated into a curved surface of the tubular POD at a first location, and a curved horizontally polarized RF antenna conformally integrated into the curved surface of the tubular POD at a second location, wherein the first location and the second location are arranged such that the curved vertically polarized RF antenna and the curved horizontally polarized RF antenna share a common RF emission axis.

In embodiments of this aspect, the disclosed aerial drone according to any one of the above example embodiments, wherein the tubular POD is composed of composite materials selected from the group consisting of fiberglass, carbon fiber, and Kevlar, providing lightness, rigidity, and aerodynamic stability to the tubular POD.

In embodiments of this aspect, the disclosed aerial drone according to any one of the above example embodiments, further comprising a heated surface in the tubular POD to prevent ice accumulation during operation in low-temperature and high-humidity atmospheres.

In embodiments of this aspect, the disclosed aerial drone according to any one of the above example embodiments, wherein the curved vertically polarized RF antenna and the curved horizontally polarized RF antenna are oriented relative to each other to reduce interference and improve compactness of the system while maintaining emission along the common RF emission axis.

In embodiments of this aspect, the disclosed aerial drone according to any one of the above example embodiments, further comprising reflectors positioned in the tubular POD to guide RF waves emitted by the curved antennas towards a target without causing interference between vertically and horizontally polarized waves.

In embodiments of this aspect, the disclosed aerial drone according to any one of the above example embodiments, wherein the curved horizontally polarized RF antenna comprises a V-shaped planar array stacking configuration, the V-shape being oriented obliquely with respect to the axis of the tubular POD to reduce angular beamwidth of a main lobe in the azimuth direction and increase area of the antenna in the direction of the POD's axis.

In embodiments of this aspect, the disclosed aerial drone according to any one of the above example embodiments, wherein radiating elements of the curved vertically polarized RF antenna and the curved horizontally polarized RF antenna are staggered along each respective antenna boom to increase length of the antennas.

In embodiments of this aspect, the disclosed aerial drone according to any one of the above example embodiments, wherein the curved vertically polarized RF antenna and the curved horizontally polarized RF antenna are oriented at a 90-degree angle relative to each other, such that the orientation of their respective radiating elements determines the polarization of emitted RF waves.

In embodiments of this aspect, the disclosed aerial drone according to any one of the above example embodiments, further comprising an aerodynamic cap on at least one end of the tubular POD, the aerodynamic cap being configured to reduce drag along the tubular POD as the drone is flying.

In embodiments of this aspect, the disclosed aerial drone according to any one of the above example embodiments, further comprising coolant lines integrated within the tubular POD, wherein the coolant lines are configured to circulate a coolant to dissipate heat generated by the curved vertically polarized RF antenna, the curved horizontally polarized RF antenna, and supporting electronic devices.

### BRIEF DESCRIPTION OF THE DRAWINGS

So that the way the above-recited features of the present disclosure can be understood in detail, a more particular description of the disclosure, briefly summarized above, may be made by reference to example embodiments, some of which are illustrated in the appended drawings. It is to be noted, however, that the appended drawings illustrate only example embodiments of this disclosure and are therefore not to be considered limiting of its scope, for the disclosure may admit to other equally effective example embodiments.

FIG. 1 depicts a drone with a tubular pod-shaped (POD) antenna system mounted thereon, according to an aspect of the disclosure.

FIG. 2 depicts the drone in FIG. 1 flying over terrain and using the tubular POD antenna system to survey the terrain and objects thereon, according to an aspect of the disclosure.

FIG. 3 depicts a perspective view of the tubular POD antenna system with radiation direction, according to an aspect of the disclosure.

FIG. 4 depicts another perspective view of the tubular POD antenna system in FIG. 3, according to an aspect of the disclosure.

FIG. 5 depicts the vertically polarized antenna in the tubular POD antenna system, according to an aspect of the disclosure.

FIG. 6 depicts the horizontally polarized antenna in the tubular POD antenna system, according to an aspect of the disclosure.

FIG. 7 depicts a cross sectional view of the POD surface material including the antenna embedded therein, according to an aspect of the disclosure.

FIG. 8 depicts a perspective view of the tubular POD antenna system with back and side RF reflectors to achieve the desired radiation direction, according to an aspect of the disclosure.

FIG. 9 depicts another perspective view of the tubular POD antenna system in FIG. 8, according to an aspect of the disclosure.

FIG. 10 depicts a block diagram of the tubular POD antenna system connected to electronic devices of the drone, according to an aspect of the disclosure.

FIG. 11 depicts a flowchart describing operation of the drone and tubular POD antenna system for performing a survey of terrain, according to an aspect of the disclosure.

### DETAILED DESCRIPTION

Various example embodiments of the present disclosure will now be described in detail with reference to the drawings. It should be noted that the relative arrangement of the components and steps, the numerical expressions, and the numerical values set forth in these example embodiments do not limit the scope of the present disclosure unless it is specifically stated otherwise. The following description of at least one example embodiment is merely illustrative in nature and is in no way intended to limit the disclosure, its application, or its uses. Techniques, methods, and apparatus as known by one of ordinary skill in the relevant art may not be discussed in detail but are intended to be part of the specification where appropriate. In all the examples illustrated and discussed herein, any specific values should be interpreted to be illustrative and non-limiting. Thus, other example embodiments may have different values. Notice that similar reference numerals and letters refer to similar items in the following figures, and thus once an item is defined in one figure, it is possible that it need not be further discussed for the following figures. Below, the example embodiments will be described with reference to the accompanying figures.

Synthetic Aperture Radar (SAR) systems mounted on aerial drones have revolutionized the field of Earth based geophysical surveys and surveillance applications. These systems are capable of generating high-resolution images of landscapes, including topography and structures, by emitting and receiving radar signals. The use of drones as a platform for SAR systems offers several advantages, including the ability to cover large areas quickly and efficiently, and the ability to access hard-to-reach or hazardous locations.

One of the primary applications of drone-borne SAR systems is in the field of underground tomography. They are also used in intelligence gathering and reconnaissance, providing valuable data about the ground and sea surfaces, including the detection of submerged vessels, oil spills and objects hidden under vegetation. Furthermore, these systems are used in precision cartography, providing detailed maps of the surveyed area. The ability of SAR systems to detect moving targets also makes them useful in monitoring oil and gas leaks in surface and subsurface pipelines. The versatility and efficiency of drone-borne SAR systems make them a beneficial tool in a wide range of fields.

The present disclosure is directed to a tubular pod-shaped (POD) antenna system, specifically designed in an aerodynamic configuration for mounting on drones. This innovative design addresses the challenges associated with traditional SAR antennas, such as size, weight, mechanical strength, and aerodynamic properties, which can limit the types of aerial platforms they can be mounted on and affect the flight performance. The tubular POD antenna system may be cylindrical in shape, which not only reduces aerodynamic drag but also enhances the drone's flight speed and stability. This aerodynamic configuration allows the drone to fly at higher speeds and altitudes, thereby increasing the SAR survey coverage performance. Furthermore, the cylindrical shape of the antenna system is designed to be easily integrated into existing POD standards for aircraft and drones, making it a versatile solution for various aerial platforms. The antenna system is also designed to withstand both subsonic and supersonic speeds of the aircraft, further enhancing its applicability and performance. The benefits of such a configuration are manifold, including improved flight safety, increased survey coverage, and enhanced operational stability in various atmospheric conditions.

While the present disclosure may describe the antenna system as having a cylindrical shape, it is noted that this is just an example, and therefore other aerodynamic shapes that are conducive to reducing drag and enhancing flight performance may also be employed. The shape of the antenna system may be adapted based on the specific requirements of the aerial platform, the operational environment, or the specific application of the SAR system. The design principles and features disclosed herein may be applied to antenna systems of various shapes while still achieving the desired performance characteristics.

Furthermore, the disclosure may describe the antenna system as operating in the P-band frequency range, it is noted that this is just an example, and therefore the antenna system may be designed to operate in other Radio Frequency (RF) bands as well. The choice of the operating frequency band may be determined based on the specific application of the SAR system, the desired penetration depth, the resolution requirements, or other operational considerations. The design and implementation principles disclosed herein may be adapted to antenna systems operating in various RF bands, providing flexibility and versatility in the application of the SAR system.

Referring to the figures, a conformal antenna system for SAR applications is disclosed. The system may generally include a tubular POD, which serves as the foundational structure (i.e., body) for the tubular POD antenna system 118. The tubular POD may be cylindrical in shape and may be designed to be aerodynamically efficient, reducing drag and allowing for high-speed operation. The tubular POD may be composed of composite materials such as fiberglass, carbon fiber, or Kevlar, providing lightness, rigidity, and stability to the POD. In some cases, the tubular POD antenna system 118 may also include a cooling system (not shown) for cooling the antennas during operation in high-temperature environments, and/or a heated surface (not shown) to prevent ice accumulation during operation in low-temperature and high-humidity environments.

Integrated into the curved surface of the tubular POD at a first location may be a curved vertically polarized radio frequency (RF) antenna. The vertically polarized RF antenna may include a vertically polarized antenna, which is responsible for emitting and receiving vertically polarized RF signals. The vertically polarized antenna may be conformally integrated into the curved surface of the tubular POD, following the curvature of the POD to maintain a compact and aerodynamic form factor. The orientation of the vertically polarized antenna may determine the polarization of the emitted RF waves.

At a second location on the curved surface of the tubular POD, a curved horizontally polarized RF antenna may be conformally integrated. The horizontally polarized RF antenna may include a horizontally polarized antenna. Similar to the vertically polarized antenna, the horizontally polarized antenna may be conformally integrated into the curved surface of the tubular POD, following the curvature of the POD. The orientation of the horizontally polarized antenna may determine the polarization of the emitted RF waves.

The first location and the second location may be arranged such that the curved vertically polarized RF antenna and the curved horizontally polarized RF antenna share a common RF emission axis. This configuration may allow the vertically and horizontally polarized RF antennas to emit RF waves along the same axis, reducing interference and maximizing the compactness of the system while maintaining emission along the common RF emission axis.

It is noted that the antennas of the disclosed SAR system may be formed from ribbons of pliable metal. This innovative design allows for the antennas to be seamlessly integrated into the tubular POD structure, enhancing the overall aerodynamic efficiency of the system. The pliable nature of the metal ribbons allows them to be conformed to the shape of the POD, whether it be on the outer surface, inner surface, or even embedded within the material of the POD itself. This flexibility in integration not just contributes to the compactness and lightweight nature of the system, but also ensures that the antennas maintain their functional integrity and performance, irrespective of their placement within the POD. This design approach can provide a versatile and efficient solution for the implementation of antennas in SAR systems, overcoming the limitations of traditional antenna designs.

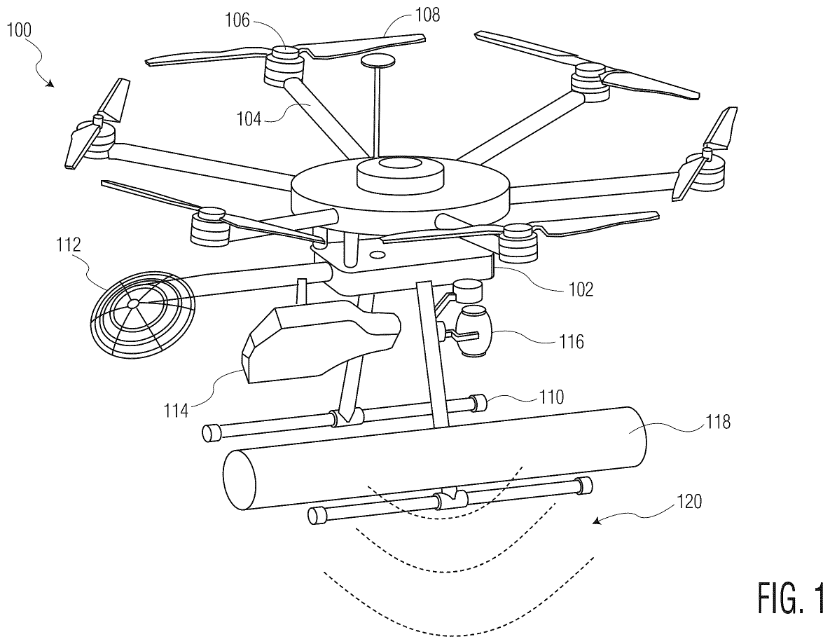

Turning to FIG. 1, an isometric view of a drone 100 is presented. The drone 100 may include a central body 102, to which multiple drone rotors 106 are attached via rotor arms 104. Each rotor 106 may include rotor blades 108. The drone 100 may also include additional antennas 112, 114 and sensor 116, which may be used for various purposes such as navigation, object detection, and data collection.

As shown in FIG. 1, below central body 102 of a drone 100, a tubular POD antenna system 118 is illustrated as being mounted to landing gear 110. The tubular POD antenna system 118 may be attached to the drone 100 and may be configured to emit and receive radio frequency (RF) signals. The tubular POD antenna system 118 may include a curved vertically polarized RF antenna and a curved horizontally polarized RF antenna, as previously described. The tubular POD antenna system 118 may be designed to be aerodynamically efficient, reducing drag and allowing for high-speed operation of the drone 100. In some cases, the tubular POD antenna system 118 may include an aerodynamic cap on at least one end, further enhancing its aerodynamic properties and reducing drag along the tubular POD.

As depicted in FIG. 1, the tubular POD antenna system 118 can be mounted to the side of the drone 100. This strategic positioning allows the tip of the POD to be aimed in the direction of the drone's flight. The orientation of the POD is such that it extends from left-to-right, in alignment with the forward movement of the drone. This configuration ensures that the emitted radio frequency (RF) signals from the POD are directed towards the area of interest, maximizing the efficiency of the SAR system during operation. The side-mounted design of the POD also contributes to the overall aerodynamic efficiency of the drone, allowing for stable and high-speed operation.

The radiation pattern or field of view is represented emanating from the tubular POD antenna system 118, indicating the area that the tubular POD antenna system 118 can be capable of scanning. The radiation pattern or field of view may be determined by the configuration and operation of the curved vertically polarized RF antenna and the curved horizontally polarized RF antenna integrated into the tubular POD antenna system 118, as well as the mounting orientation of the POD on the drone. In this configuration, the tubular POD antenna system 118 is capable of scanning ground objects off the lateral side of the drone during flight.

The tubular POD antenna system 118 may also designed to be rotatable along its axis. This rotation capability allows for the control of the angle at which the radio frequency (RF) signals are emitted and received with respect to the ground. By adjusting the rotation of the POD, the technician can control the direction and angle of the scan, thereby targeting specific areas of interest on the ground. The rotation of the POD along its axis can be achieved through the use of static mechanical mounts or mechanical actuators (not shown) integrated into the mounting system of the POD. It is noted that rotation of the POD along its axis does not affect the aerodynamic properties of the drone 100 or the POD itself. The cylindrical shape of the POD may ensure that it maintains its aerodynamic efficiency irrespective of its rotation, allowing for stable and high-speed operation of the drone. This rotation capability, combined with the aerodynamic design of the POD, contributes to the overall performance and versatility of the SAR system.

In some cases, the tubular POD antenna system 118 may have an adequate structural configuration that enables it to support both the subsonic and supersonic speeds of the drone 100. This may allow the drone 100 to operate at a wide range of speeds while maintaining effective operation of the tubular POD antenna system 118. The ability to support both subsonic and supersonic speeds may enhance the versatility and utility of the drone 100 in various SAR applications.

As described above, drone 100 may include a suite of antennas and sensors, each configured to operate at different frequency bands to accomplish a variety of objectives. Antenna 112, for example, may be a non-conformal antenna designed for use in the L-band frequency range, such as between 1200 and 1400 MHz, which could be utilized for earth observation and surface penetration applications. Sensor 114 may be a radar body equipped with C-band antennas, such as those operating within the 5200 to 5600 MHz frequency range, suitable for high-resolution imaging and surface analysis. Sensor 116 may include infrared (IR) and/or visible light cameras, which provide complementary information to the radar data, useful for applications such as surveillance, reconnaissance, and environmental monitoring. The combination of L-band and C-band radar sensors, along with the P-band tubular POD antenna system 118, offers a comprehensive set of tools for a wide range of applications. The inclusion of both radar bands and cameras allows the system to be versatile, catering to applications that require all three radar bands and infrared or visual data, as well as those that may require just a single band or camera type. By integrating this diverse array of sensors, the drone system can cover an extensive range of applications, making it a powerful tool for various geophysical and surveillance tasks.

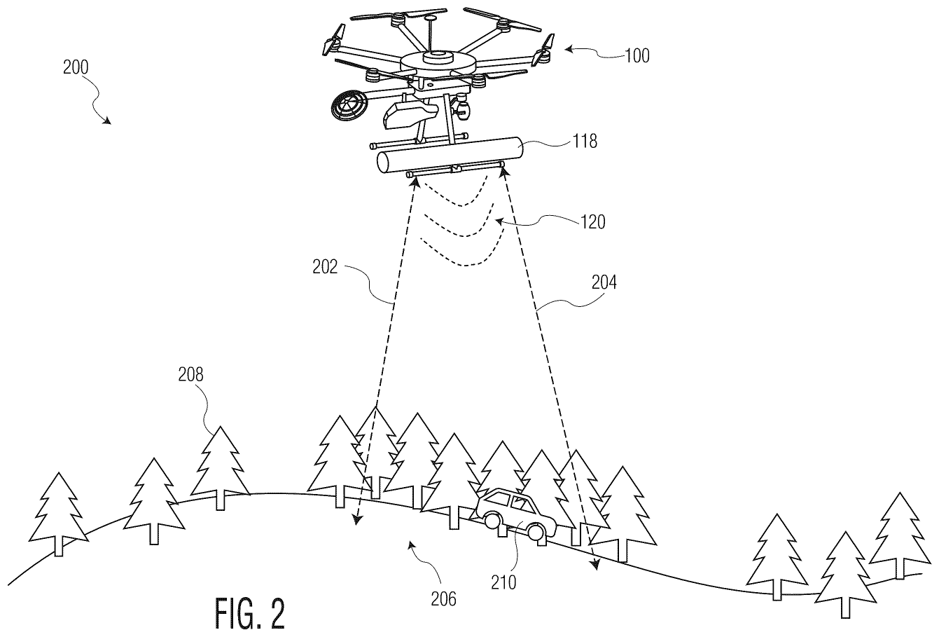

Turning to FIG. 2, an orthogonal side view 200 of a drone 100 in operation is presented. The drone 100 is equipped with a tubular POD antenna system 118, which may be configured to transmit radar signals 120 towards the ground or terrain 206. These radar signals 120 may be reflected (backscattered) back to the drone 100 within the range of field of view as measured between 202 and 204. The radar signals 120 may have the capability to penetrate through various types of obstacles, such as trees 208, and may be reflected back to the drone system as reflected radar signals, allowing for the detection of objects beneath the tree canopy or even beneath the ground surface. For instance, the system may be capable of detecting objects such as a vehicle 210 located beneath the tree canopy. This illustration demonstrates the capability of the drone system to survey and collect data from both the ground and subsurface environments.

In some cases, the tubular POD antenna system 118 may enable the drone 100 to perform a helical pattern flight for surface and subsurface tomographic SAR survey. This flight pattern may allow the drone 100 to cover a larger area and collect more comprehensive data from the ground and subsurface environments than other flight patterns. The radar signals 120 emitted by the tubular POD antenna system 118 during this helical pattern flight may be reflected back to the drone 100, providing valuable data for the creation of detailed surface and subsurface maps. This operational variation may enhance the versatility and utility of the drone 100 in various SAR applications.

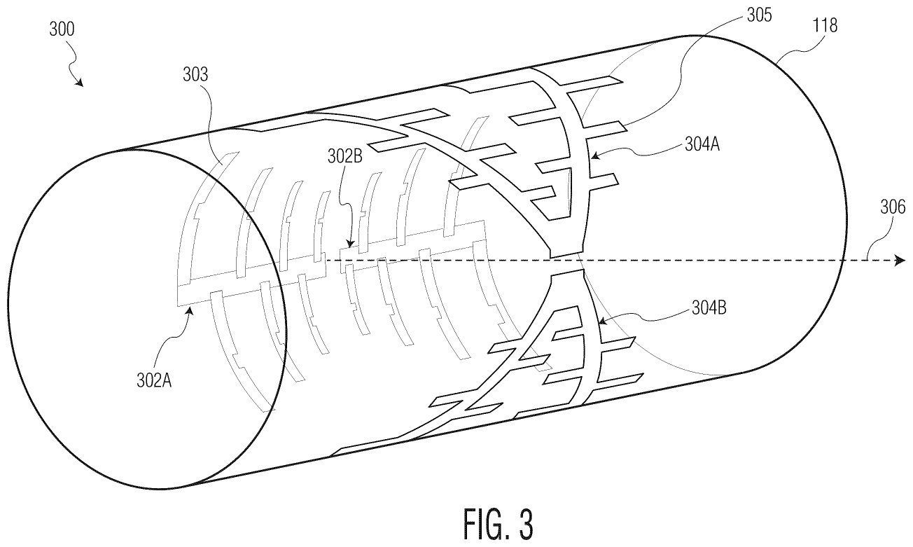

Turning to FIG. 3, a transparent view 300 of the tubular POD antenna system 118 is presented, showing the internal arrangement of antenna elements. Inside the cylindrical POD, the vertically polarized antenna including vertically polarized antenna segments 302A and 302B with radiating elements 303, and the horizontally polarized antenna including horizontally polarized antenna segments 304A and 304B with radiating elements 305 are also conformally integrated within the tubular POD antenna system 118. The vertically polarized antenna segments 302A and 302B and the horizontally polarized antenna segments 304A and 304B may be oriented at an angle relative to each other, such that the orientation of their respective radiating elements 303 and 305 are oriented at a 90-degree angle relative to each other. This configuration may allow the vertically and horizontally polarized RF antennas to emit RF waves along common emission axis 306 ensuring that the antennas are scanning the same ground target.

In some cases, the radiating elements 303 and 305 of the curved vertically polarized RF antenna and the curved horizontally polarized RF antenna may be staggered along each respective antenna boom in a log-periodic manner to increase the length of the antennas. This configuration may enhance the performance of the antennas and may allow for a wider scanning coverage area for the emitted RF waves.

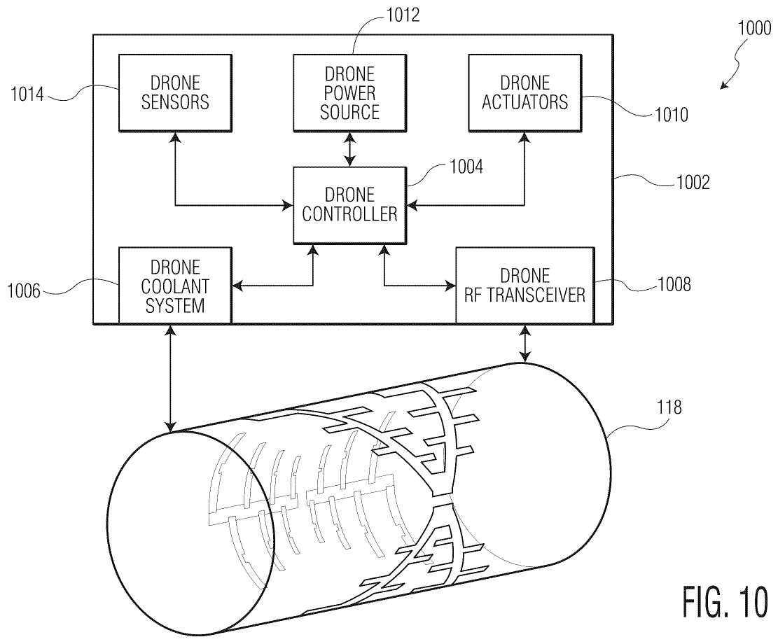

In one embodiment, the tubular POD antenna system 118 is capable of operating across a wide range of transmission powers, from milliwatts up to several kilowatts, to accommodate various SAR application requirements. Tubular POD antenna system 118 may be effective for P and L bands ranging from 100 MHz to 2 GHz but is not limited to these bands. Return loss is a measure of how well an antenna is matched to the transmission line and how much power is reflected back due to mismatch. Therefore, a lower return loss is better than a higher return loss. In one example, the disclosed system may achieve a return loss better than −10 dB, ranging, for example, between −6 dB and −20 dB, within its operational frequency range. The expected gain of the antenna system may be above 9 dB, with an anticipated gain, for example, of 10 dB within the working frequency range. In one example, the operational frequency range of the system may span from 10 MHz to 1 GHZ, with a bandwidth that can vary from a few MHz to several hundred MHz. In an example, the angular 3 dB beamwidth of the main lobes of the tubular POD antenna system 118 may be within 25-45 degrees in azimuth and 50-77 degrees in elevation, although depending on the specific antenna size and design, these angles may range, for example, between 30 and 120 degrees. This operational configuration may enhance the performance of the tubular POD antenna system 118 in various SAR applications. Of course, operational power and bandwidth are configurable for specific applications. In some cases, the tubular POD antenna system 118 may use two separate 50-ohm input impedance connectors (not shown) to connect coaxial cable or the like to the antennas and drone transceiver. Further details of electrical and coolant connections between tubular POD antenna system 118 and the drone are described in FIG. 10. It is noted that the above recited numerical values are non-limiting examples.

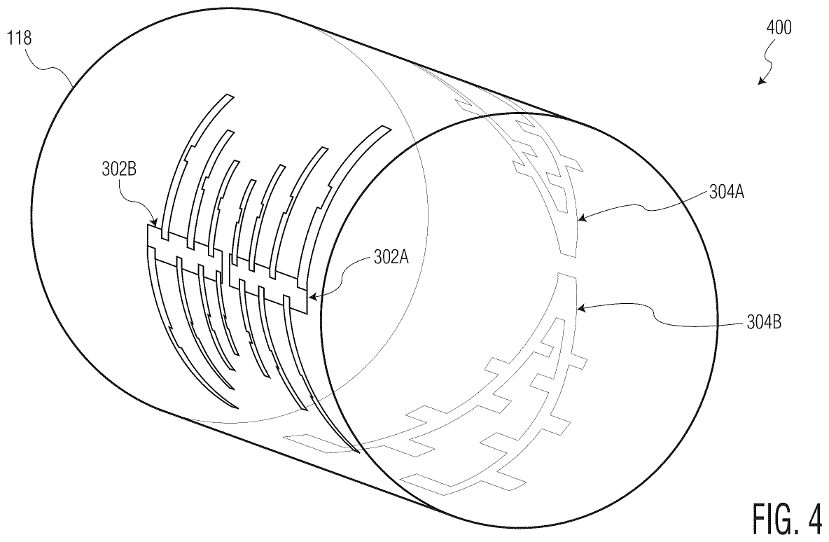

Turning now to FIG. 4, a perspective view 400 of a cylindrical antenna system is presented. FIG. 4 presents a back-side view of the tubular POD antenna system 118, as shown in FIG. 3. This perspective provides a clear view of the integrated antenna elements within the POD. The vertically polarized antenna segments 302A and 302B, as well as the horizontally polarized antenna segments 304A and 304B, are visible in this view. These antenna segments are conformally integrated into the structure of the tubular POD antenna system 118, following its cylindrical shape. Again, the orientation of these antenna segments is such that they are rotated 90 degrees relative to each other, allowing for the emission and reception of both vertically and horizontally polarized radio frequency signals.

As depicted in FIG. 3 and FIG. 4, the tubular POD antenna system 118 is shown to be hollow. This hollow structure is not merely an empty space but serves as a housing for various components that are integral to the operation of the antenna system and the drone. For example, the cavity of the tubular POD antenna system 118 may house various components (not shown) such as electrical wiring, electrical devices, and a coolant/heating system. The electrical wiring within the POD may serve to connect the vertically polarized antenna segments 302A and 302B and the horizontally polarized antenna segments 304A and 304B to the drone's RF transceiver and power source. This wiring enables the transmission and reception of RF signals by the antenna system, as well as the supply of power to the antennas. Electrical devices housed within the POD may include RF electronics, power supply units, and real-time processors. These devices are integral to the operation of the antenna system and the drone, enabling the transmission and reception of RF signals, the supply of power to the antennas, and the processing of the received RF signals to generate SAR images. The coolant/heating system within the POD may serve to regulate the temperature of the antenna system and the housed electrical devices. This system may be particularly useful in maintaining the operational stability of the antenna system and the drone in various environmental conditions.

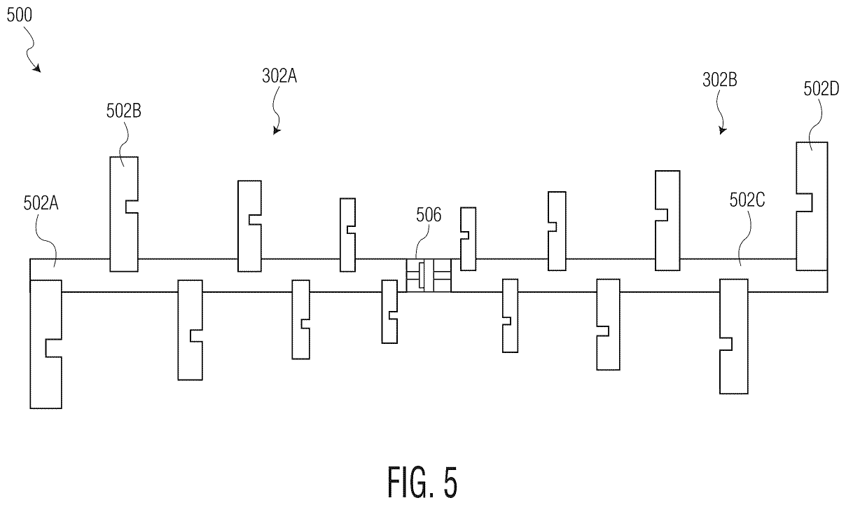

Turning to FIG. 5, a top view of a vertically polarized antenna 500 is provided. The vertically polarized antenna configuration may include a central feed point 506, from which two vertically polarized antenna segments, first vertically polarized antenna segment 302A and second vertically polarized antenna segment 302B, extend outward. The central feed point 506 may serve as the point of origin for the RF waves emitted by the vertically polarized antenna segments 302A and 302B. The central feed point 506 may be designed to efficiently distribute the RF energy to the vertically polarized antenna segments 302A and 302B, ensuring uniform emission of RF waves along the common RF emission axis.

The first vertically polarized antenna segment 302A may include a first beam 502A, which may include a plurality of vertically polarized radiating elements 502B extending therefrom. Similarly, the second vertically polarized antenna segment 302B may include a second beam 502C, which can include a plurality of vertically polarized radiating elements 502D extending therefrom. The vertically polarized radiating elements 502B and 502D may be responsible for emitting and receiving vertically polarized RF signals.

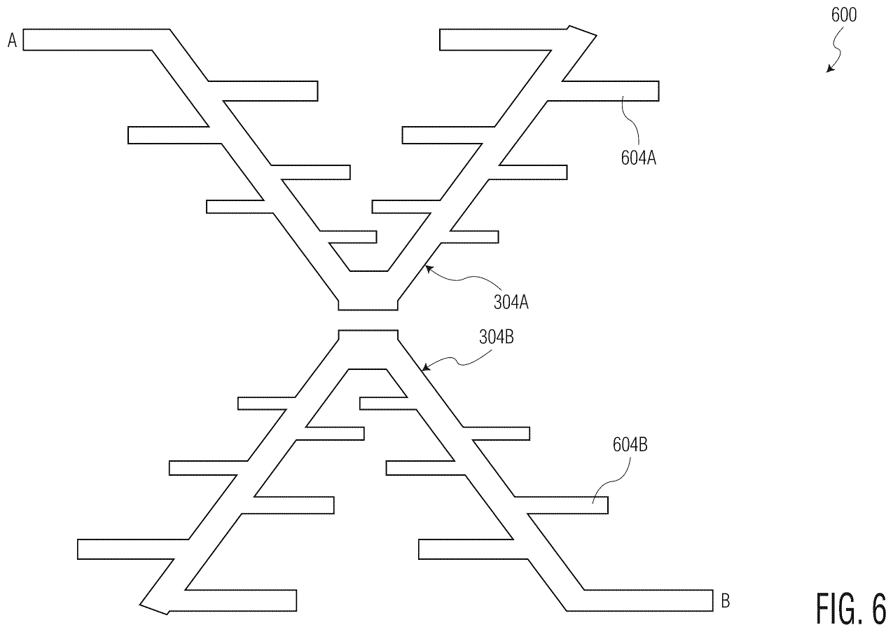

Turning to FIG. 6, a schematic representation of horizontally polarized antenna structure 600 is provided. This structure can include a horizontally polarized antenna segment 304A with a plurality of horizontal radiating elements 604A, and a horizontally polarized antenna segment 304B with a plurality of horizontal radiating elements 604B. In some examples, the guiding elements of the horizontally polarized antenna segment 304A and the horizontally polarized antenna segment 304B extend outward in a V-shape configuration. This V-shape configuration may be oriented obliquely with respect to the axis of the tubular POD antenna system 118, also referred to as the common emission axis 306. This oblique orientation may serve to reduce the angular beamwidth of the main lobe in the azimuth direction and increase the antenna's area in the direction of the POD's axis.

The V-shape configuration of the antenna shown in FIG. 6 can provide both physical and Radio Frequency (RF) benefits, enhancing the overall performance of the antenna system. For example, this configuration enables the integration of a larger antenna area in the direction of the POD's axis, without increasing the physical size of the POD. This is particularly beneficial in maintaining the compactness and lightweight nature of the antenna system, which in turn contributes to the aerodynamic efficiency of the drone. The V-shape configuration of the horizontally polarized antenna segments 304A and 304B also can provide several RF benefits. Firstly, this configuration allows for a reduction in the angular beamwidth of the main lobe in the azimuth direction. This reduction in beamwidth enhances the directional accuracy of the emitted RF waves, enabling more precise scanning of the ground and subsurface environments. Secondly, the V-shape configuration enables the horizontally polarized antenna segments 304A and 304B to emit RF waves along the same axis as the vertically polarized antenna segments 302A and 302B. This common emission axis allows for simultaneous scanning of the same ground target by both vertically and horizontally polarized RF waves. This capability enhances the versatility of the antenna system, allowing for the detection and classification of a wider range of objects and features in the surveyed area.

It is noted that the radiating elements of the antennas shown in FIG. 5 and FIG. 6 are arranged in a log-periodic configuration. This configuration is a feature of the antenna design which plays a role in its performance and functionality. In a log-periodic antenna configuration, the antenna elements, also referred to as ‘stubs’, are arranged along the antenna boom in a manner such that their lengths and spacings increase logarithmically from one end of the antenna to the other. This arrangement allows the antenna to operate effectively over a wide range of frequencies, making it a beneficial configuration for applications such as SAR systems that require operation over a broad bandwidth. Furthermore, the log-periodic configuration of the radiating elements enables the antenna system to maintain a consistent radiation pattern over its operating frequency range. This consistency in the radiation pattern may be beneficial in SAR applications, where the quality and accuracy of the generated images are dependent on the uniformity of the radiation pattern. It is also worth noting that the log-periodic configuration of the radiating elements contributes to the compact and lightweight design of the antenna system. By varying the lengths and spacings of the radiating elements logarithmically, the antenna system can achieve a high level of performance while maintaining a compact form factor, making it suitable for integration into a variety of aerial platforms such as drones, aircraft, and helicopters.

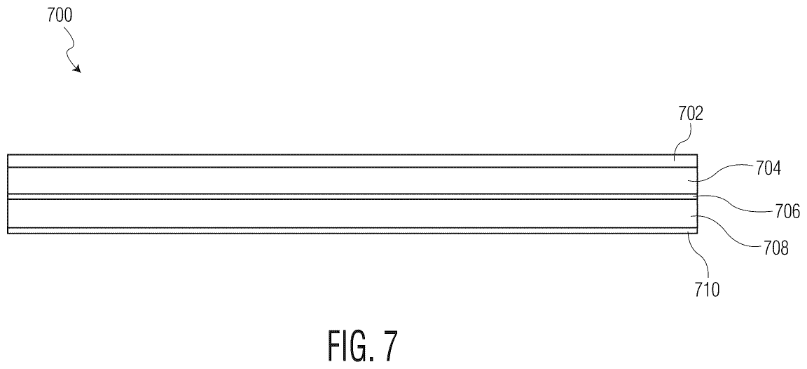

FIG. 7 provides a representative side view of the layered structure 700 of the antenna system. This structure can include multiple layers arranged in a sequence. In some examples, each layer is represented as a distinct band, and they are in direct contact with one another, forming a cohesive unit.

The first layer 702 represents the antenna segments (vertically/horizontally polarized segments). These are the antenna beams and active elements of the antenna system that are responsible for transmitting and receiving the radio frequency signals. The antenna segments are designed to be conformal to the shape of the POD, allowing for a compact and aerodynamic design.

The second layer 704 represents a Printed Circuit Board (PCB) substrate. This substrate serves as a mounting platform for the antenna segments. The PCB substrate can provide a stable and rigid base for the antenna segments, ensuring their proper alignment and positioning within the POD. This second layer 704 is designed to be an aerodynamically efficient surface reducing drag and allowing for high-speed operation of the drone. The first layer 702 (i.e., antennas) is adhered to this second layer 704. The third layer 706 represents the outer surface of the POD. The outer surface can also provide a protective barrier for the antenna segments and the PCB substrate, shielding them from environmental factors such as wind, rain, and temperature fluctuations.

It is noted that the antenna segments described above may be a thin metal structure (e.g., with a thickness of about 70 microns) adhered to the surface of second layer 704. In addition, although not shown, a paint layer (applied on over the first layer 702 in FIG. 7) may act as a protective barrier for the antenna segments and the PCB substrate, shielding them from environmental factors such as wind, rain, and temperature fluctuations.

The third layer 706 represents the outer surface of the POD onto which the second layer 704 is adhered to. The fourth layer 708 represents the material of the POD. This material may be a composite material such as fiberglass, carbon fiber, or Kevlar, providing lightness, rigidity, and stability to the POD. The POD material also ensures the structural integrity of the antenna system, allowing it to withstand the physical stresses associated with high-speed flight. The fifth layer 710 represents the inner surface of the POD. This inner surface can provide additional structural support for the antenna system and serves as a barrier between the antenna segments and the internal components of the POD. The inner surface may also be designed to be thermally conductive, helping to dissipate heat generated by the antenna segments during operation.

FIG. 7 shows the antennas formed on the outer surface of the POD following its curvature. Alternatively, the antennas can be formed on the inner surface of the POD. In this configuration, the antennas are attached to the inner surface of the POD, again following its curvature. This placement protects the antennas from external environmental factors, such as wind and rain, while still allowing them to effectively transmit and receive radio frequency signals.

Another possible configuration is to integrate the antennas directly within the material of the POD itself. In this configuration, the antennas are embedded within the composite material of the POD during the POD molding process. This integration can provide additional protection for the antennas, shielding them from both external environmental factors and physical stresses associated with high-speed flight. Furthermore, integrating the antennas within the POD material allows for a more compact and lightweight design, which is beneficial for the overall performance of the SAR system.

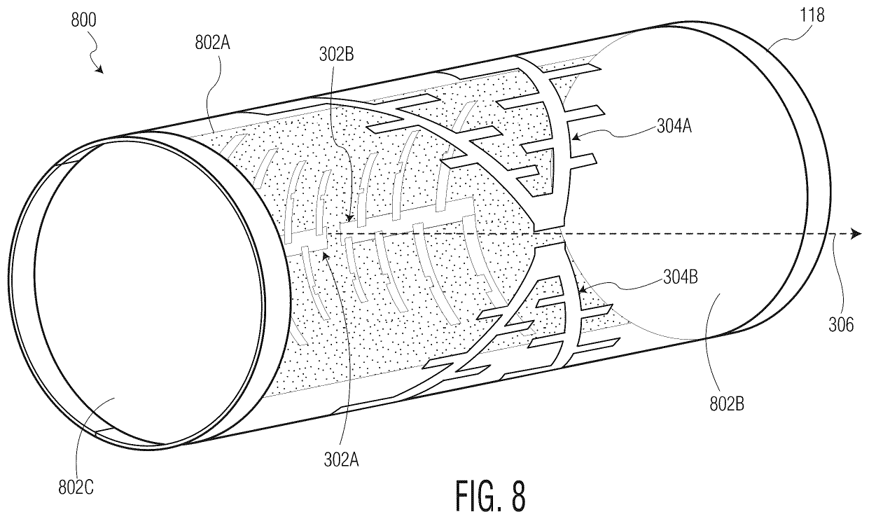

Turning to FIG. 8, a transparent view 800 of the tubular POD antenna system 118 is presented. The tubular POD antenna system 118 can include vertically polarized antenna segments 302A and 302B and horizontally polarized antenna segments 304A and 304B, which are integral parts of the antenna structure. The tubular POD antenna system 118 can also include RF reflectors such as back reflector 802A and side reflectors 802B and 802C. The radiation direction is shown as the common emission axis 306.

In some cases, the tubular POD antenna system 118 may include these RF reflectors positioned at specific locations around the POD to guide the RF waves emitted by the antennas towards a common target. Specifically, the back reflector 802A and side reflectors 802B and 802C may be strategically positioned within the tubular POD antenna system 118 to guide the RF waves emitted by the curved vertically polarized RF antenna and the curved horizontally polarized RF antenna towards a common target along common emission axis 306. This configuration may allow for efficient use of the RF energy and may enhance the performance of the antenna system in various SAR application. The use of reflectors may also prevent interference between the vertically and horizontally polarized waves, ensuring clear and accurate data collection.

In some variations, an aerial drone 100 equipped with the tubular POD antenna system 118 including these reflectors may be better equipped to guide the RF waves emitted by the antennas towards a desired target area. For example, a drone equipped with the tubular POD antenna system may be flown in a specific survey pattern over the target area. This may be a linear flight pattern for topography estimation or a helical flight pattern for surface and subsurface tomographic surveys. The flight pattern may be designed to ensure that the drone and the antenna system cover the target area comprehensively. Simultaneously, the tubular POD antenna system, which can include a vertically polarized antenna and a horizontally polarized antenna, emits RF waves towards the ground. Moreover, RF reflectors, specifically including a back reflector and side reflectors ensure that the RF waves are directed along the common RF emission axis, enhancing the efficiency of the RF energy usage and improving the performance of the antenna system in various SAR applications. For example, during an aerial survey of a forested area for intelligence gathering, the drone may fly over the target area in a predetermined pattern. As the drone flies, the tubular POD antenna system emits RF waves towards the ground. These waves penetrate the forest canopy and are reflected back to the antenna system by the ground and any objects on it. The back reflector and side reflectors in the tubular POD antenna system guide these emitted RF waves towards the target area, ensuring that the area is scanned comprehensively. The reflected waves are then received by the antenna system and processed to generate a high-resolution image of the target area.

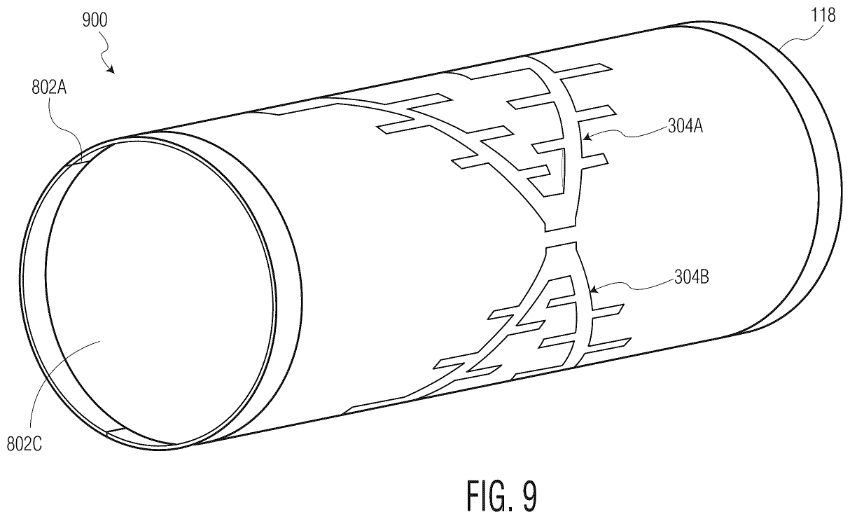

FIG. 9 presents another view 900 of the tubular POD antenna system 118, providing a perspective of the reflectors relative to the antennas. In this example, side reflector 802C is shown to cover the full side of the tubular POD antenna system 118. This extensive coverage ensures that the RF waves emitted by the antenna do not radiate out of the ends of the POD. The back reflector 802A is also depicted as covering the back half of the tubular POD antenna system 118. This strategic placement of the back reflector 802A helps reflect waves emitted towards the backside of the POD thereby ensuring directional RF scanning.

The size and configuration of the side reflector 802C and the back reflector 802A are set based on the antenna segment configurations and the dimensions of the tubular POD antenna system 118. This design consideration ensures that the reflectors are appropriately sized and positioned to guide the RF waves effectively, thereby maximizing the performance of the antenna system.

Turning to FIG. 10, a block diagram of the drone system 1000 is presented, illustrating the interconnections between its various electronic components 1002. The drone controller 1004 may serve as the central processing unit, receiving input from the drone sensors 1014 and controlling the drone actuators 1010. The drone controller 1004 may be responsible for managing the operation of the drone 100, including controlling the flight of the drone, managing the operation of the tubular POD antenna system 118, and processing data received from the Drone Sensors 1014.

The drone power source 1012 may supply power to the drone controller 1004, drone actuators 1010, drone RF transceiver 1008, and drone sensors 1014. The drone power source 1012 may be a battery or any other suitable power source capable of providing sufficient power for the operation of the drone 100 and its various components. In some cases, the drone power source 1012 may be rechargeable, allowing for extended operation of the drone 100.

The drone RF transceiver 1008, which may handle communication, is also connected to the drone controller 1004. The drone RF transceiver 1008 may be responsible for transmitting and receiving RF signals, including the RF signals emitted and received by the tubular POD antenna system 118. The drone RF transceiver 1008 may also communicate with a remote control station or other devices, allowing for remote operation and control of the drone 100.

The drone coolant system 1006 may be linked to the drone controller 1004 and may be responsible for regulating the temperature of the system. The drone coolant system 1006 may include coolant lines integrated within the tubular POD antenna system 118. The coolant lines may be configured to circulate a coolant to dissipate heat generated by the curved vertically polarized RF antenna, the curved horizontally polarized RF antenna, and supporting electronic devices. This configuration may prevent overheating of the system and may enhance the operational stability and longevity of the tubular POD antenna system 118.

In some cases, the tubular POD antenna system 118 may include a heated surface to prevent ice accumulation during operation in low-temperature and high-humidity environments. This feature may enhance the operational stability of the drone 100 in various environmental conditions and may prevent performance degradation due to ice accumulation on the tubular POD antenna system 118. In some variations, the tubular POD antenna system 118 may use heat pipe technology to transfer the heat generated by the electronic systems to the cylindrical surface.

In one example, the drone coolant system 1006 and the drone RF transceiver 1008 are interfaced with the tubular POD antenna system 118. For example, drone coolant system 1006 may be coupled to coolant lines extending through the tubular POD, while RF transceiver 1008 may be electrically connected to the antennas and other POD electronic devices.

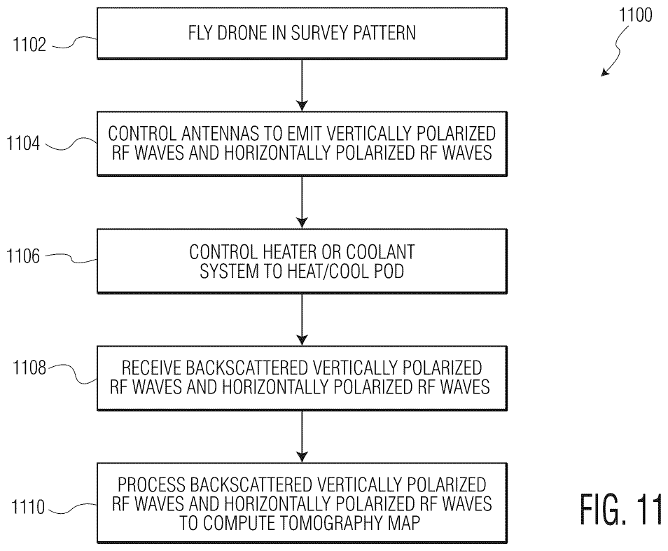

Turning to FIG. 11, a flowchart 1100 outlining a process for operating a drone 100 equipped with a SAR system is presented. The process generally includes the steps of flying the drone 1102, controlling the antennas 1104, controlling the heater or coolant system 1106, receiving backscattered signals 1108 and processing the backscattered signals 1110. The steps are now described in detail.

The process may begin with the step of flying the drone in a survey pattern 1102. In some cases, the survey pattern may be a linear flight track, a helical flight pattern, or any other suitable flight pattern that allows for efficient coverage of the survey area. The flight pattern may be determined based on the specific requirements of the SAR survey, such as the size and shape of the survey area, the type of terrain, and the desired resolution of the survey data.

Following the initiation of the flight pattern, the process may proceed to the step of controlling the antennas to emit vertically polarized RF waves and horizontally polarized RF waves 1104. In this step, the curved vertically polarized RF antenna and the curved horizontally polarized RF antenna integrated into the tubular POD antenna system 118 may be controlled to emit RF waves along a common emission axis 306. The RF waves may be emitted in a specific frequency band, such as the UHF band, and may be polarized either vertically or horizontally depending on the orientation of the antenna elements. The emission of the RF waves may be controlled to optimize the coverage of the survey area and to reduce interference between the vertically and horizontally polarized waves.

The process may then proceed to the step of controlling a heater or coolant system 1106. In this step, a heater or coolant system, such as the drone coolant system 1006, may be controlled to regulate the temperature of the tubular POD antenna system 118 and its internal components. This may prevent overheating of the system and may enhance the operational stability and longevity of the tubular POD antenna system 118. In some cases, the heater or coolant system may also prevent ice accumulation on the tubular POD antenna system 118 during operation in low-temperature and high-humidity environments.

After the heater or coolant system has been controlled, the process may proceed to the step of receiving backscattered vertically polarized RF waves and horizontally polarized RF waves 1108. In this step, the curved vertically polarized RF antenna and the curved horizontally polarized RF antenna may receive backscattered RF waves that have been reflected off the ground or terrain 206 and other objects in the survey area. The backscattered RF waves may carry information about the ground and subsurface environments, which can be used to create detailed surface and subsurface maps.

The next step in the process may be to process the backscattered vertically polarized RF waves and horizontally polarized RF waves to compute a tomography map 1110. In this step, the backscattered RF waves received by the antennas may be processed to extract the information they carry about the ground and subsurface environments. This information may then be used to compute a map of the survey area, providing a detailed representation of the ground and subsurface environments. The computed map may be used for various applications, such as intelligence gathering, reconnaissance, detection of underground structures, precision cartography, and detection of moving targets.

An example algorithm that may be used to process the backscattered signals received by the Conformal P-band Antenna for SAR Application to compute a map of the surveyed area may include various steps. For example, the acquired backscattered signals may be preprocessed to remove any noise and to normalize the signal strength. This preprocessing step may involve techniques such as filtering, amplification, and normalization. The preprocessed backscattered signals may then be converted from the time domain to the frequency domain using a Fourier Transform. This conversion allows for the extraction of the frequency components of the signals, which carry information about the ground and subsurface environments. The frequency components of the backscattered signals may then be analyzed to extract the phase and amplitude information. This analysis may involve techniques such as spectral analysis and phase unwrapping. The phase and amplitude information extracted from the backscattered signals may then be used to form an image of the surveyed area. This image formation step may involve techniques such as inverse Fourier Transform and SAR imaging algorithms. The formed image may then be postprocessed to enhance the image quality and to highlight the features of interest. This postprocessing step may involve techniques such as filtering, contrast enhancement, and edge detection. The postprocessed image may be used to generate a map of the surveyed area. This map generation step may involve techniques such as georeferencing, projection, and rasterization. This algorithm is just an example, and the actual implementation may vary depending on the specific requirements of the SAR application, the characteristics of the surveyed area, and the capabilities of the drone and the Conformal P-band Antenna for SAR Application.

While the foregoing is directed to example embodiments described herein, other and further example embodiments may be devised without departing from the basic scope thereof. For example, aspects of the present disclosure (e.g., operation of the drone controller) may be implemented in hardware or software or a combination of hardware and software. One example embodiment described herein may be implemented as a program product for use with a computer system. The program(s) of the program product defines functions of the example embodiments (including the methods described herein) and may be contained on a variety of computer-readable storage media. Illustrative computer-readable storage media include, but are not limited to: (i) non-writable storage media (e.g., read-only memory (ROM) devices within a computer, such as CD-ROM disks readably by a CD-ROM drive, flash memory, ROM chips, or any type of solid-state non-volatile memory) on which information is permanently stored; and (ii) writable storage media (e.g., floppy disks within a diskette drive or hard-disk drive or any type of solid-state random-access memory) on which alterable information is stored. Such computer-readable storage media, when carrying computer-readable instructions that direct the functions of the disclosed example embodiments, are example embodiments of the present disclosure.

It will be appreciated by those skilled in the art that the preceding examples are exemplary and not limiting. It is intended that all permutations, enhancements, equivalents, and improvements thereto are apparent to those skilled in the art upon a reading of the specification and a study of the drawings are included within the true spirit and scope of the present disclosure. It is therefore intended that the following appended claims include all such modifications, permutations, and equivalents as fall within the true spirit and scope of these teachings.

What is claimed is:

1. A conformal antenna system for Synthetic Aperture Radar (SAR) applications, the system comprising:
a tubular POD;
a curved vertically polarized radio frequency (RF) antenna conformally integrated into a curved surface of the tubular POD at a first location; and
a curved horizontally polarized RF antenna conformally integrated into the curved surface of the tubular POD at a second location,
wherein the first location and the second location are arranged such that the curved vertically polarized RF antenna and the curved horizontally polarized RF antenna share a common RF emission axis.

2. The conformal antenna system of claim 1, wherein the tubular POD comprises a composite material selected from the group consisting of fiberglass, carbon fiber, and Kevlar.

3. The conformal antenna system of claim 1, further comprising a heated surface on the tubular POD configured to prevent ice accumulation.

4. The conformal antenna system of claim 1, wherein the curved vertically polarized RF antenna and the curved horizontally polarized RF antenna are oriented relative to each other to reduce interference and improve compactness of the system while maintaining emission along the common RF emission axis.

5. The conformal antenna system of claim 1, further comprising:
reflectors positioned in the tubular POD to guide RF waves emitted by the curved vertically polarized RF antenna and the curved horizontally polarized RF antenna towards a common target without causing interference between the vertically and horizontally polarized waves.

6. The conformal antenna system of claim 1, wherein the curved horizontally polarized RF antenna comprises a V-shaped planar array stacking configuration, the V-shape being oriented obliquely with respect to the axis of the tubular POD to reduce angular beamwidth of a main lobe in an azimuth direction and increase an area of the antenna in the direction of the POD's axis.

7. The conformal antenna system of claim 1, wherein radiating elements of the curved vertically polarized RF antenna and the curved horizontally polarized RF antenna are staggered along each respective antenna boom to increase a length of curved vertically polarized RF antenna and the curved horizontally polarized RF antenna.

8. The conformal antenna system of claim 1, wherein the curved vertically polarized RF antenna and the curved horizontally polarized RF antenna are oriented at a 90-degree angle relative to each other, such that the orientation of their respective radiating elements determines the polarization of emitted RF waves.

9. The conformal antenna system of claim 1, further comprising:
an aerodynamic cap on at least one end of the tubular POD, the aerodynamic cap being configured to reduce drag along the tubular POD.

10. The conformal antenna system of claim 1, further comprising:
coolant lines integrated within the tubular POD, wherein the coolant lines are configured to circulate a coolant to dissipate heat generated by the curved vertically polarized RF antenna, the curved horizontally polarized RF antenna, and supporting electronic devices.

11. An aerial drone configured for conducting aerial surveys of ground objects and subsurface objects, the drone comprising:
a body; and
a conformal antenna system mounted to a side of the body, wherein an axis of the conformal antenna system is oriented in a flying direction of the drone such that radio frequency (RF) emissions radiate from the side of the drone down towards Earth, the conformal antenna system comprising:
a tubular POD,
a curved vertically polarized RF antenna conformally integrated into a curved surface of the tubular POD at a first location, and
a curved horizontally polarized RF antenna conformally integrated into the curved surface of the tubular POD at a second location,
wherein the first location and the second location are arranged such that the curved vertically polarized RF antenna and the curved horizontally polarized RF antenna share a common RF emission axis.

12. The aerial drone of claim 11, wherein the tubular POD comprises a composite material selected from the group consisting of fiberglass, carbon fiber, and Kevlar.

13. The aerial drone of claim 11, further comprising:
a heated surface in the tubular POD configured to prevent ice accumulation.

14. The aerial drone of claim 11, wherein the curved vertically polarized RF antenna and the curved horizontally polarized RF antenna are oriented relative to each other to reduce interference and improve compactness of the system while maintaining emission along the common RF emission axis.

15. The aerial drone of claim 11, further comprising:
reflectors positioned in the tubular POD to guide RF waves emitted by the curved antennas towards a target without causing interference between vertically and horizontally polarized waves.

16. The aerial drone of claim 11, wherein the curved horizontally polarized RF antenna comprises a V-shaped planar array stacking configuration, the V-shape being oriented obliquely with respect to the axis of the tubular POD to reduce angular beamwidth of a main lobe in the azimuth direction and increase area of the antenna in the direction of the POD's axis.

17. The aerial drone of claim 11, wherein radiating elements of the curved vertically polarized RF antenna and the curved horizontally polarized RF antenna are staggered along each respective antenna boom to increase length of the antennas.

18. The aerial drone of claim 11, wherein the curved vertically polarized RF antenna and the curved horizontally polarized RF antenna are oriented at a 90-degree angle relative to each other, such that the orientation of their respective radiating elements determines the polarization of emitted RF waves.

19. The aerial drone of claim 11, further comprising:
an aerodynamic cap on at least one end of the tubular POD, the aerodynamic cap being configured to reduce drag along the tubular POD as the drone is flying.

20. The aerial drone of claim 11, further comprising:
coolant lines integrated within the tubular POD, wherein the coolant lines are configured to circulate a coolant to dissipate heat generated by the curved vertically polarized RF antenna, the curved horizontally polarized RF antenna, and supporting electronic devices.
